(19) United States
(12) Patent Application Publication
(10) Pub. No.: US 2009/0135076 A1
(43) Pub. Date: May 28, 2009

(54) LINEAR ANTENNA ARRAY WITH AZIMUTH BEAM AUGMENTATION BY AXIAL ROTATION

(76) Inventor: Senglee Foo, Irvine, CA (US)

Correspondence Address: Myers Andras Sherman LLP, 19900 MacArthur Blvd., Suite 1150, Irvine, CA, 92612, US

(21) Appl. No.: 12/323,438

(22) Filed: Nov. 25, 2008

Related U.S. Application Data
(60) Provisional application No. 61/004,525, filed on Nov. 28, 2007.

(51) Int. Cl. H01Q 19/18; H01Q 21/00

(52) U.S. Cl. 343/836; 343/839

(57) ABSTRACT

An antenna array with azimuth beam width that can be continuously augmented through on-axis rotation of a single-column or a dual-column linear array is disclosed. Alternate radiating elements in the vertical direction are arranged on separate reflectors which are movable to change their angle in the azimuth to alter beam width.

### RELATED APPLICATION INFORMATION

The present application claims priority under 35 USC section 119(e) to U.S. provisional patent application Ser. No. 61/004,525 filed Nov. 28, 2007, the disclosure of which is incorporated herein by reference in its entirety.

### BACKGROUND OF THE INVENTION

1. Field of the Invention

The present invention relates in general to communication systems and components. More particularly the present invention is directed to antennas and antenna arrays employed in wireless communications systems.

2. Description of the Prior Art and Related Background Information

Modern wireless antenna implementations generally include a plurality of radiating elements that may be arranged over a ground plane defining a radiated (and received) signal beam width and azimuth scan angle. Azimuth antenna beam width can be advantageously modified by varying amplitude and phase of an RF signal applied to respective radiating elements. Azimuth antenna beam width has been conventionally defined by Half Power Beam Width (HPBW) of the azimuth beam relative to a bore sight of such antenna array. In such antenna array structure radiating element positioning is critical to the overall beam width control as such antenna systems rely on accuracy of amplitude and phase angle of the RF signal supplied to each radiating element. This places severe constraints on the tolerance and accuracy of a mechanical phase shifter to provide the required signal division between various radiating elements over various azimuth beam width settings.

Consequently, there is a need to provide a simpler method to adjust antenna beam width control.

### SUMMARY OF THE INVENTION

In a first aspect the present invention provides an antenna for a wireless network, comprising a first reflector having a first plurality of radiators coupled thereto and a second reflector having a second plurality of radiators coupled thereto, wherein the first and second plurality of radiators are arranged in a generally vertical direction with alternate radiators alternately configured on the first and second reflectors, and wherein the first and second reflectors are rotatable in opposite angular directions in the azimuth to alter signal beam width.

In a preferred embodiment of the antenna the first and second reflectors are partially overlapping with an interlocking comb shape and provide a generally rectangular shape in combination. Alternate radiators are configured in notched portions of the opposite comb shaped reflector. The first and second plurality of radiators may comprise patch antenna radiating elements. The first and second reflectors are preferably generally planar. The first and second reflectors are preferably movable through an angular range of between 0 degrees and about 40 degrees and half power beam width is variable between about 36 and 120 degrees. The first and second plurality of radiators are preferably offset from a center axis of the vertical arrangement in opposite directions by a total distance d in the azimuth when the reflectors are at a 0 degree relative angle. The first and second reflectors are preferably offset from a rotation axis by an amount Δd, where Δd is substantially smaller than d. Preferably Δd is also substantially smaller than the operational wavelength of the antenna. The antenna preferably further comprises a shaft extending in the vertical direction and the first and second reflectors are coupled to the shaft.

In another aspect the present invention provides an antenna array, comprising a first reflector structure having plural reflector panels spaced apart in a vertical direction, a first plurality of radiators coupled to the plural reflector panels of the first reflector structure and configured in pairs on each panel, wherein the radiators in each pair are spaced apart in an azimuth direction, a second reflector structure having plural reflector panels spaced apart in the vertical direction and alternating with the plural reflector panels of the first reflector structure, and a second plurality of radiators coupled to the plural reflector panels of the second reflector structure and configured in pairs on each panel, wherein the radiators in each pair are spaced apart in the azimuth direction. The first and second plurality of radiators are arranged in two columns extending in the vertical direction when the plural panels of the first and second reflector structures are in a first generally aligned configuration, and the plural panels of the first and second reflector structures are movable together in opposite angular directions in the azimuth to alter signal beam width of the antenna array.

In a preferred embodiment of the antenna array the plural panels of the first and second reflector structures form a generally X shaped overall configuration when moved in opposite directions away from the aligned configuration. The plural panels of the first and second reflector structures are planar and generally rectangular in shape. The array has a relatively narrow beam width in the first generally aligned configuration and a beam width which increases with the angular separation of the first and second reflector structures in the azimuth. The first and second reflector structures are rotatable in opposite angular directions in the azimuth preferably through a range of about 40 degrees and the half power beam width ranges between about 38 and 102 degrees. The antenna array may preferably further comprise a shaft extending in the vertical direction and the plural panels of the first and second reflector structures are coupled to the shaft. The two columns of radiators formed when the plural panels of the first and second reflector structures are in a first generally aligned configuration are spaced apart a distance d, the first and second reflector panels are preferably offset from a rotation axis by an amount Δd, and Δd is preferably substantially smaller than d. The first and second plurality of radiators may comprise patch radiating elements.

In another aspect the present invention provides a method of adjusting signal beam width in a wireless antenna having a plurality of radiators configured on plural separate reflector panels. The method comprises providing the reflector panels in a first configuration to provide a first signal beam width and rotating the panels in opposite angular directions in the azimuth to a second configuration to provide a second signal beam width.

In a preferred embodiment of the method the plural panels comprise first and second groups of panels movable together and plural radiators are configured on each panel.

Further features and aspects of the invention are provided in the following detailed description.

### BRIEF DESCRIPTION OF THE DRAWINGS

FIG. 1A is a front view and FIG. 1B a top view of a variable beam width antenna array in accordance with the first embodiment of the invention.

FIG. 2A is a front view and FIG. 2B a top view of a variable beam width antenna array in accordance with the second embodiment of the invention.

FIG. 3 is a graphical representation of simulated azimuth beam patterns in accordance with the first embodiment of the invention.

FIG. 4 is a graphical representation of simulated azimuth beam patterns in accordance with the second embodiment of the invention.

FIG. 5 is a typical pattern of amplitude tapering in accordance with the second embodiment of the invention.

### DETAILED DESCRIPTION OF THE INVENTION

The present invention provides an antenna array with mechanical azimuth beam width control. In the illustrated embodiments beam width can be continuously augmented through on-axis rotation of a single-column or a dual-column linear array.

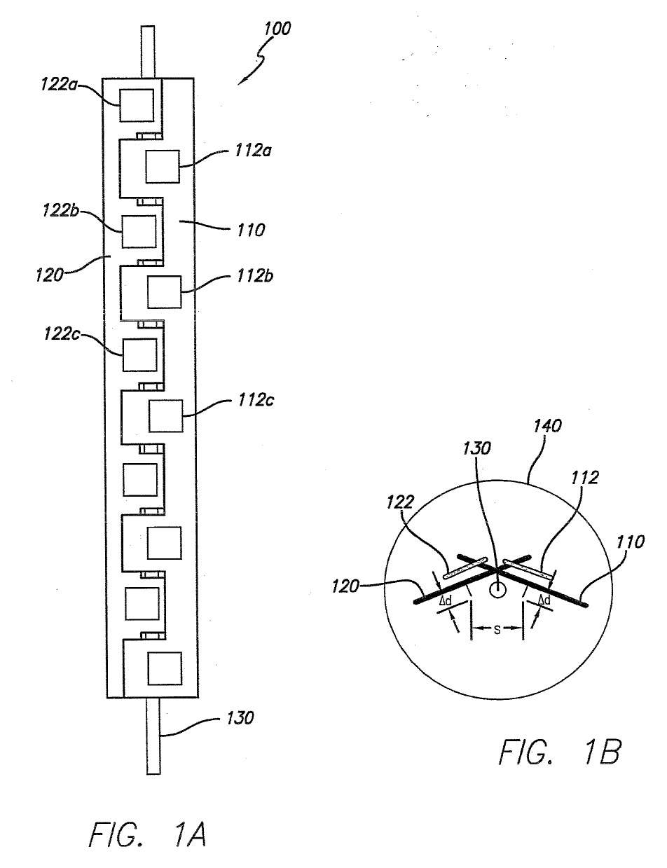

FIGS. 1A and 1B show the single-column embodiment of the present invention in front and top views, respectively. The antenna array 100 includes a first reflector 110 and a second reflector 120 movably mounted for rotational movement, for example about a mounting rod 130. Various actuation mechanisms are possible and for example may couple to the reflector panels at the top and/or bottom of the reflector panels to effect rotation of the panels in opposite angular directions in the azimuth. For example, the teachings of U.S. provisional patent application Ser. No. 61/004,242 filed Nov. 26, 2007 may be employed for the actuation mechanism and coupling to the panels, the disclosure of which is incorporated herein by reference in its entirety. Also, in place of one rod 130 two separate rods may be employed each coupled to one of the reflector panels and separately driven to effect rotation of the reflector panels. A first group of plural radiating elements 112 are configured on first reflector panel 110 and a second group of plural radiating elements 122 are configured on second reflector panel 120. The radiating elements are illustrated generally as patch antenna elements but other radiators may be employed as well known to those skilled in the art. These radiating elements of the array are arranged in off-center positions between alternate elements in the azimuth direction. Furthermore, radiating elements are mounted on different reflectors, alternately. For example, as shown in FIG. 1A a first radiating element 112a on reflector 110 is shifted to the right from a center axis in the azimuth while radiating element 122a on reflector 120 is shifted to the left. This alternating pattern of offsets continues as shown and a comb like reflector shape may accommodate partial reflector overlap as shown. The entire array can be suitably enclosed in a cylindrical radome 140 (FIG. 1B).

The nominal distance of center offset between the alternate elements in the azimuth direction (d), i.e., the distance at zero rotation angle, is important to the overall azimuth pattern of the antenna. A larger offset distance allows more beam width variation in the azimuth direction. However, as the distance increases, the side lobe level in the azimuth also increases. The maximum offset distance is therefore limited by the maximum allowed side-lobe-level. This also limits the maximum achievable directivity of the single column array. The rotation angle (α) also affects this distance creating an instantaneous spacing s (FIG. 1B) which increases with the angle. Specifically, s=d+2Δd sin (α) where Δd is the offset of the reflector plane from the axis of rotation. It is desirable to maintain Δd relatively small compared to both the nominal azimuth spacing between radiators d and the operating wavelength of the antenna. For example, Δd may preferably be about 10% or less of both parameters. To increase the azimuth beam width, the two reflectors are rotated in opposite directions as shown in FIG. 1B to create a generally X shaped configuration viewed from above. The maximum rotation angle is preferably limited to about ±40 deg.

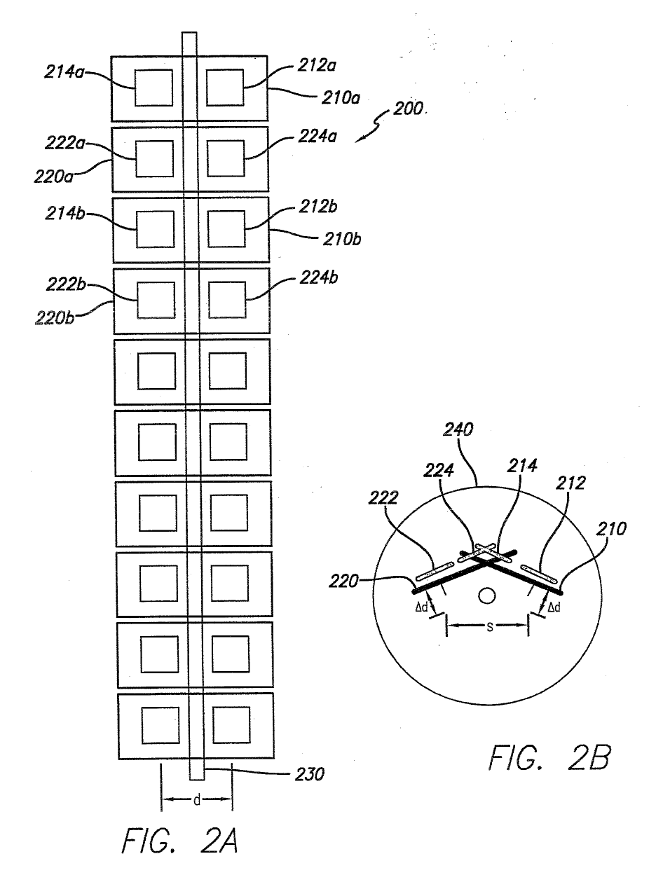

FIGS. 2A and 2B show the present invention in the embodiment of a two-column array 200 in front and top views, respectively. In this case, the radiating elements are arranged in a regular two-column fashion spaced a nominal distance d in the azimuth direction. However, these radiating elements are mounted on different reflectors alternately, as in the single-column case, to allow rotation in opposite angular directions. Therefore, for example radiating elements 212a and 224a are configured in a first column but are on separate reflectors 210a, 220a. Similarly, radiating elements 214a and 222a are configured in a second column but are on separate reflectors 210a, 220a. The separate reflector panels of reflectors 210 and 220 are coupled to move together about rod 230 and may be actuated by a suitable mechanism coupled to the plural reflector panels making up reflectors 210 and 220, respectively. Various actuation mechanisms are possible and for example may comprise two extended drive elements, such as shafts or rods, coupled to the plural reflector panels of each of reflectors 210 and 220 to effect rotation of the panels in opposite angular directions in the azimuth. For example, the teachings of U.S. provisional patent application Ser. No. 61/004,242 filed Nov. 26, 2007 may be employed for the actuation mechanism and coupling to the panels, the disclosure of which is incorporated by reference in its entirety. Also, in place of one support rod 230 two separate rods may be employed each coupled to the plural reflector panels of reflectors 210 and 220 respectively and separately driven to effect rotation of the reflector panels. The nominal element spacing in the azimuth direction (d) and the displacement of phase center of the radiating elements in the Z-direction (Δd) are important parameters as in the first embodiment. The displacement of the phase center (Δd) must be relatively small in comparison to the nominal element spacing (d) in the azimuth to maintain a instantaneous spacing s within a desired value. Also, Δd should be relatively small compared to the operating wavelength of the antenna. For example, Δd should preferably be less than about 10% of both parameters. As in the first embodiment, to increase the azimuth beam width, the two reflectors are rotated in opposite directions as shown in FIG. 2B to create a generally X shaped configuration viewed from above. The maximum rotation angle is preferably limited to about ±40 deg.

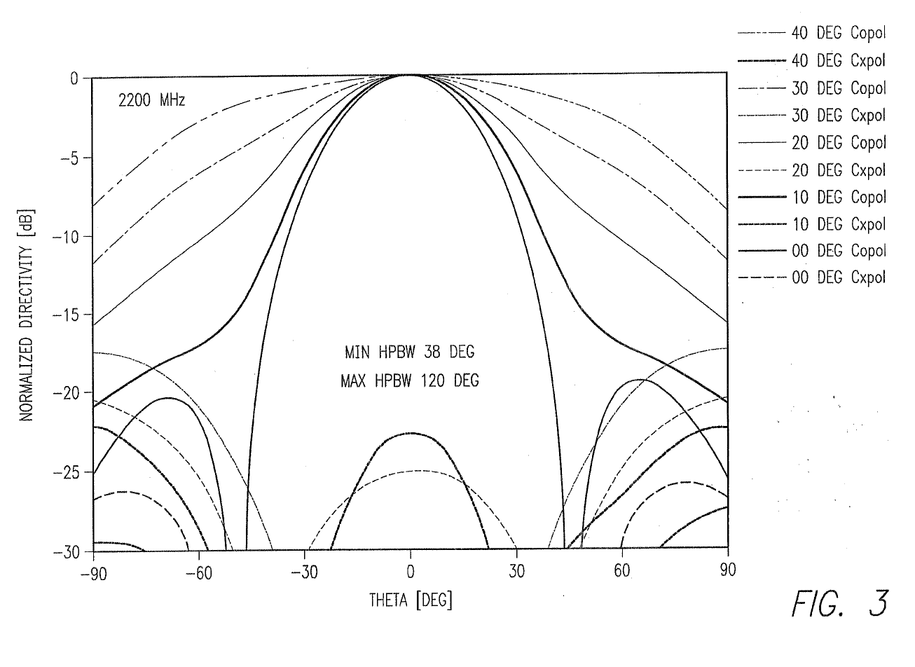

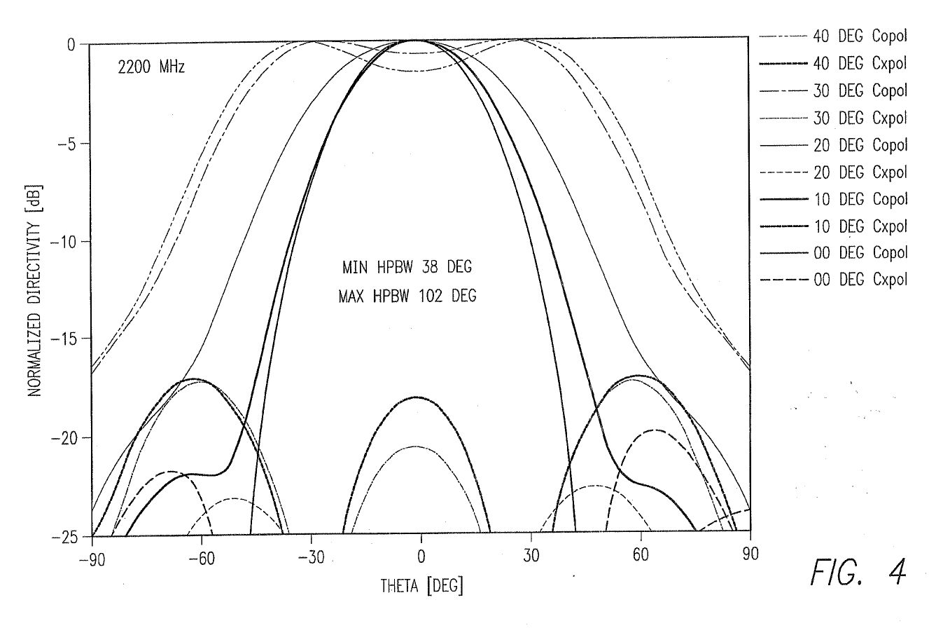

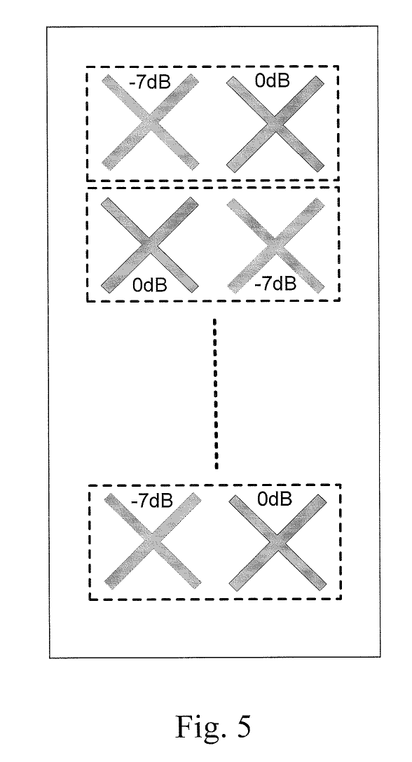

FIG. 3 and FIG. 4 show simulated typical azimuth patterns for the first and second embodiments of the antenna array, respectively, at different angles of the reflectors ranging between 0 and 40 deg. Both radiation patterns are for a 2200 MHz operating frequency. FIG. 3 illustrates the pattern for a nominal element spacing d of 9 cm while FIG. 4 illustrates the pattern for a nominal element spacing d of 95 cm. Both co and cross polarization patterns are shown. As shown both embodiments provide substantial beam width control. The two-column embodiment provides a higher directivity at the expense of a smaller beam width variation. However, beam split may possibly occur at higher rotation angle. This deficiency can be remedied by imposing amplitude taper between the two elements in the azimuth direction. The amount of amplitude taper is a compromise between the desired array directivity and the maximum achievable azimuth beam width before the occurrence of beam split. FIG. 5 shows a typical pattern of 7 dB amplitude tapering.

The foregoing description of preferred embodiments is presented for purposes of illustration and description. Furthermore, the description is not intended to limit the invention to the form disclosed herein. Accordingly, variants and modifications consistent with the following teachings, and skill and knowledge of the relevant art, are within the scope of the present invention. The embodiments described herein are further intended to explain modes known for practicing the invention disclosed herewith and to enable others skilled in the art to utilize the invention in equivalent, or alternative embodiments and with various modifications considered necessary by the particular application(s) or use(s) of the present invention.

What is claimed is:

1. An antenna for a wireless network, comprising:
a first reflector having a first plurality of radiators coupled thereto; and
a second reflector having a second plurality of radiators coupled thereto;
wherein the first and second plurality of radiators are arranged in a generally vertical direction with alternate radiators alternately configured on said first and second reflectors,
wherein said first and second reflectors are rotatable in opposite angular directions in the azimuth to alter signal beam width.

2. The antenna of claim 1, wherein said first and second reflectors are partially overlapping with an interlocking comb shape and provide a generally rectangular shape in combination.

3. The antenna of claim 2, wherein alternate radiators are configured in notched portions of the opposite comb shaped reflector.

4. The antenna of claim 1, wherein the first and second plurality of radiators comprise patch antenna radiating elements.

5. The antenna of claim 1, wherein the first and second reflectors are generally planar.

6. The antenna of claim 1, wherein the first and second reflectors are movable through an angular range of between 0 degrees and about 40 degrees and wherein half power beam width is variable between about 36 and 120 degrees.

7. The antenna of claim 1, wherein the first and second plurality of radiators are offset from a center axis of the vertical arrangement in opposite directions by a total distance d in the azimuth when the reflectors are at a 0 degree relative angle.

8. The antenna of claim 7, wherein the first and second reflector are offset from a rotation axis by an amount Δd, wherein Δd is substantially smaller than d.

9. The antenna of claim 8, wherein Δd is substantially smaller than the operational wavelength of the antenna.

10. The antenna of claim 1, further comprising a shaft extending in the vertical direction and wherein said first and second reflectors are coupled to said shaft.

11. An antenna array, comprising:
a first reflector structure having plural reflector panels spaced apart in a vertical direction;
a first plurality of radiators coupled to the plural reflector panels of the first reflector structure and configured in pairs on each panel, wherein the radiators in each pair are spaced apart in an azimuth direction;
a second reflector structure having plural reflector panels spaced apart in said vertical direction and alternating with the plural reflector panels of said first reflector structure; and
a second plurality of radiators coupled to the plural reflector panels of the second reflector structure and configured in pairs on each panel, wherein the radiators in each pair are spaced apart in said azimuth direction;
wherein the first and second plurality of radiators are arranged in two columns extending in the vertical direction when the plural panels of the first and second reflector structures are in a first generally aligned configuration, and
the first and second plurality of radiators are generally amplitude tapered in alternate fashion in the vertical direction;
wherein the plural panels of the first and second reflector structures are movable together in opposite angular directions in the azimuth to alter signal beam width of the antenna array.

12. The antenna array of claim 11, wherein the plural panels of the first and second reflector structures form a generally X shaped overall configuration when moved in opposite directions away from said aligned configuration.

13. The antenna array of claim 11, wherein the plural panels of the first and second reflector structures are planar and generally rectangular in shape.

14. The antenna array of claim 11, wherein the array has a relatively narrow beam width in said first generally aligned configuration and a beam width which increases with the angular separation of the first and second reflector structures in the azimuth.

15. The antenna of claim 14, wherein the first and second reflector structures are rotatable in opposite angular directions in the azimuth through a range of about 40 degrees and wherein the half power beam width ranges between about 36 and 102 degrees.

16. The antenna array of claim 11, further comprising a shaft extending in the vertical direction and wherein said plural panels of said first and second reflector structures are coupled to said shaft.

17. The antenna array of claim 11, wherein said two columns of radiators formed when the plural panels of the first and second reflector structures are in a first generally aligned configuration are spaced apart a distance d, wherein the first and second reflector panels are offset from a rotation axis by an amount Δd, and wherein Δd is substantially smaller than d.

18. The antenna of claim 11, wherein the first and second plurality of radiators comprise patch radiating elements.

19. A method of adjusting signal beam width in a wireless antenna having a plurality of radiators configured on plural separate reflector panels, the method comprising:
providing the reflector panels in a first configuration to provide a first signal beam width; and rotating the panels in opposite angular directions in the azimuth to a second configuration to provide a second signal beam width.

20. The method of claim 19, wherein said plural panels comprise first and second groups of panels movable together and wherein plural radiators are configured on each panel.
